(19) United States
(12) Patent Application Publication
(10) Pub. No.: US 2002/0148950 A1
(43) Pub. Date: Oct. 17, 2002

(54) Entertainment gadget

(76) Inventor: David Wilder, Oberndorf (DE)

Correspondence Address: MCGLEW & TUTTLE, PC, SCARBOROUGH STATION, SCARBOROUGH, NY, 10510, US

(21) Appl. No.: 09/817,454

(22) Filed: Aug. 10, 2001

(30) Foreign Application Priority Data
Mar. 16, 2001 (DE) DE 201 04 762.4

(51) Int. Cl. H01J 40/14

(52) U.S. Cl. 250/214 VT

(57) ABSTRACT

An entertainment device includes a nightvisionscope. The nightvisionscope may be fixed on the body or on the head of the user. This may be provided using a mounting (4) on the fastening (3) to fix the nightvisionscope on the headgear, in particular on the helmet. A hinge on the mounting may be used. A head strip may be provided on the fastening. Periscopes may be used between ocular and objective on the nightvisionscope.

This invention is about an entertainment gadget, particularly a sport gadget or a gadget for children with the characteristics in generic term of the main claim.

It is difficult for bikers and especially for mountain-bikers to see in darkness.

Until now this problem has been solved with lights on the bike or on the helmet.

However the intensity of the rays and the profundity of the lights is relatively low and decreases the justifiable speed according to the safety regulations.

Moreover the latitude view is restricted.

The value as an experience of biking in the sport-, adventure- and entertainment sector—biking as hobby or in the sport sector—is therefore restricted.

It is the task of this available invention to find a possibility to improve the entertainment and sport factors.

This invention solves the task with an entertainment gadget with the characteristics in the main claim.

The nightvisionscope extends the view possibilities in darkness and increases the value as an experience and the fun of sport activities.

In a lot of cases only this opens the possibilities for sport and entertainment in darkness. This is suitable for bikers, especially for mountain bikers.

Their view no longer depends on normal light facilities.

The biker can do without the lights on the bike or can use a weak light.

The nightvisionscope can be fixed directly on the head with a special fastening or on a headgear, particularly at a helmet.

As it can be fixed directly on the head and over the eyes you can move the head and the gadget accompanies the movements.

Moreover it stays on the right place and fulfills the functioning even during fast driving and vibration.

The entertainment gadget with the nightvisionscope can also be used for other kinds of sport, for example jogging, inline-skating or something of that kind.

It can also be used as playing gadget or as safety mechanism, especially for children. When the children weak up at night they can see without light with the nightvisionscope.

There are also other fields of application in many different entertainment areas.

For example more than one person can wear the nightvisionscope and can move in a dark room to play war games or other games or to take part in competitions.

Orientation games and orientation competitions are also possible. Special actions with or for the entertainment gadget can be for example inline-skating in groups on a dark path.

In the second claim further advantages of the invention are mentioned.

The invention is described schematically and by means of examples in the drawings.

LIST IN DETAILS

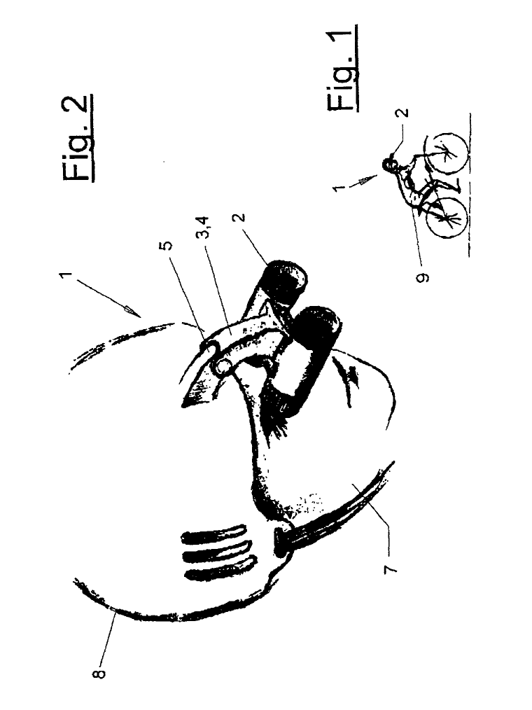

FIG. 1: A biker with an entertainment gadget equipped with an nightvisionscope

FIG. 2: An enlarged, perspective view from the head area of the biker with the nightvisionscope in operation position

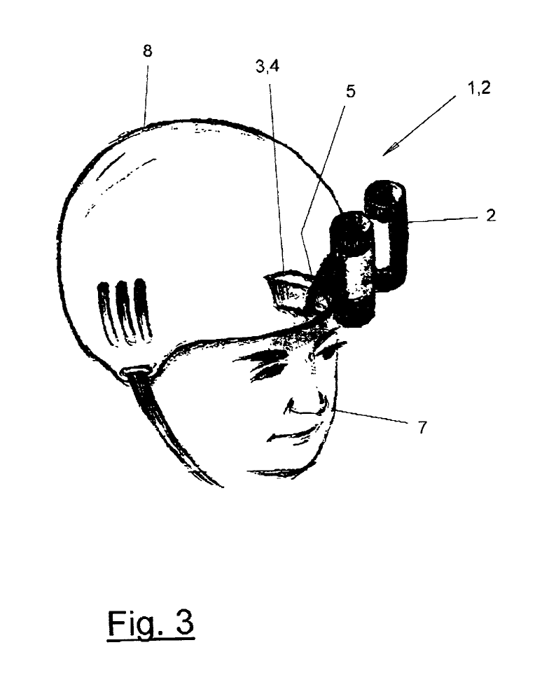

FIG. 3: One variant of FIG. 2 with the nightvisionscope in calm position

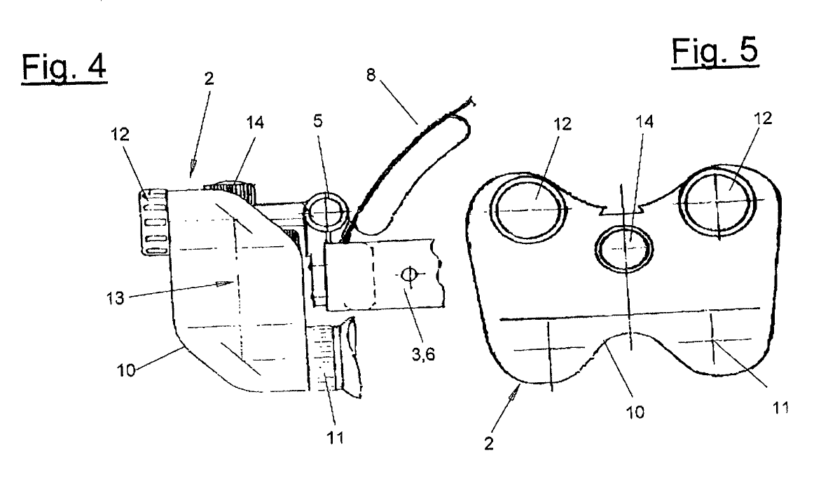

FIG. 4 and 5: Side elevation and flapped drawing of an nightvisionscope

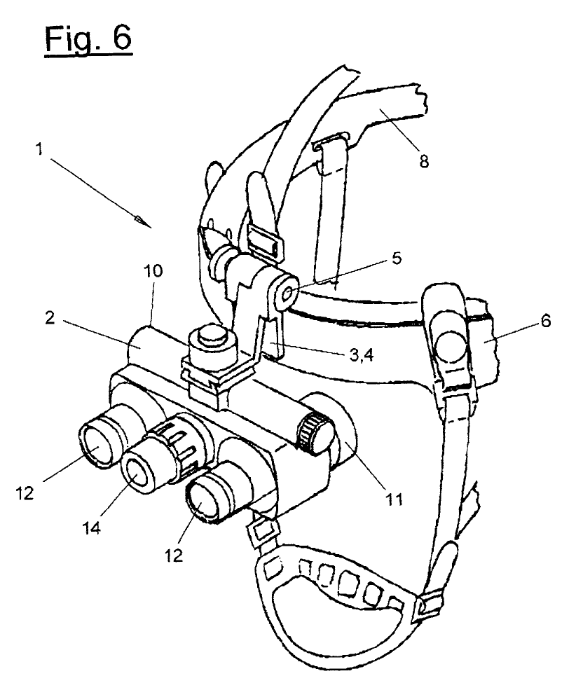

FIG. 6: One further variant of the nightvisionscope in perspective view

The drawings describe an entertainment gadget (1) which is equipped with a nightvisionscope (2)

The nightvisionscope includes a rest light amplifier and a picture transformer (not indicated in the drawing).

Through the rest light amplifier the nightvisionscope offers the possibility of a good view in weak surrounding light or in weak lights with light in visible wavelength.

With integration of an infra-red source of light even eyesight in total darkness is possible.

The entertainment gadget (1) is used for example as sport gadget. FIG. 1 shows a favour using area for bikers, in particular for racing cyclists or a mountain bikers.

Moreover there are other civilian application areas in the entertainment-, sport-, and game sector in which this gadgets are put to use.

The nightvisionscope (2) has a fastening (3) with which it can be fixed on the body of the user, especially on the head.

The fastening (3) can be shaped differently. In particular it has to show a mounting to fix a headgear (8).

In the execution example in the drawings the biker (9) wears a helmet (8) which is fixed with an chin strap or in an other suitable way on the head (7).

The mounting (4) is fastened on the helmet (8) and carries the nightvisionscope (2) in a suitable position in front of the eyes of the user.

The mounting (4) has either a hinge (5) or other appropriate movement facilities with which the nightvisionscope (2) can be flapped from the operation position in front of the eyes (FIG. 1) into a calm position (FIG. 3) or also moved in another way.

The mounting (4) can be integrated in the helmet (8).

Existing helmets, for example bike helmets can also be refitted with suitable fastening means.

In another variant (FIG. 6) the nightvisionscope (2) can be also used on different head protections (8) for joggers or other sportsmen.

This kind of head protection (8) is more comfortable to wear and not heavy.

In the variant of FIG. 6 the head protection (8) consists of an arrangement of straps with a head strap (6), which covers the temple, of one ore more straps around the head (7) and of one strap with chin fastening.

The chin fastening can be like a soft blister, which is fixed on the head (7) with a chin strap or other facilities.

The nightvisionscope (2) is fixed at the front of the head strip (6) with a fastening (3) which exists of a hinge (5) with folding device (4).

The fastening (3) has a moving sledge or a similar facility that the nightvisionscope is adjustable horizontally and vertically in front of the head and the eyes.

With this fastening the nightvisionscope accompanies the movements of the head and stays in operation position in front of the eyes of the user.

In a further variant the nightvisionscope (2) can also be made like glasses, which are for example only equipped with an elastic head strap (6) (indicated in FIG. 4).

In this or other variants the nightvisionscope (2) made like glasses can also be made with seals on both sides, tight-fitting on the head (7) like diver's goggles and therefore can be used under water and in other difficult surroundings.

Nightvisionscopes are used and well-known by pilots and marksmen in the whole military sector. In this case the gadgets are heavy and massif and they need an airplane or other vehicles to provide them with electricity.

For the civilian use, entertainment, and in particular for the use in the sport and game sector the nightvisionscope (2) is equipped in an other way.

It is not that heavy, just a few 100 grams, of a far smaller construction size and is easy to wear on the head (7) during physical action like jogging or biking.

This nightvisionscope (2) is simpler equipped than the military version.

For the use as entertainment gadget the nightvisionscope (2) has a short construction depth.

The length of the rays way can be guaranteed by the position of the periscopes (13) (indicated in FIGS. 4 and 5).

In this variant of nightvisionscope (2) (FIGS. 4 and 5) which mainly has the shape of glasses there are two objectives and two oculars which are arranged in different heights with the corresponding mirrors or prisms to guide the rays within the case.

The objectives are in this case above the oculars adjusted in direction to the eyes of the user.

The nightvisionscope (2) is equipped preferably with infra-red lights (14) to switch on and out which you can find for example on the front of the case between the objectives.

In the execution form of FIG. 8 the both objectives are arranged in about the same height than the oculars in which the objectives jut out of the case.

Between the objectives (12), on the other hand, infra-red-lights to switch on and out can also be arranged.

For operation the nightvisionscope (2) has an integrated supply of energy, which for example exists of one or more batteries arranged at the case (10).

They provide the rest light amplifier, the picture transformer and if need be the infra-red lights (14) with electric energy.

For a longer use and if more energy is required it is also possible to carry a supply of energy fixed extern on the body.

This can be additional batteries with wire connections which are fixed on the headgear (8) particularly on the helmet.

Other fastening possibilities are on the clothes of the user in special bags or something of that kind.

Instead of batteries, in particular accumulators also other suitable kinds of supply of energy or power supply, especially, can be used.

The nightvisionscope (2) has a fix focus device (not indicated) with objectives of touch focal length and a special intensity.

In the most cases of using the nightvisionscope in the entertainment- and sport sector an intensity of up to 25 meter is sufficient.

However, also other kinds of objectives (12) with other focal lengths and other areas of intensity can be used.

If need be the objectives (12) can also be changed.

The renunciation of a focus devise and the corresponding mechanical and moving parts decreases the construction size and the weight of the nightvisionscope. (2)

In addition to that this also decreases the energy required.

In the most cases a fix focus device and a restricted area of intensity of about 25 meter is sufficient for bikers. (9)

This is also the real view, which the biker normally has during the day and in which he sees clear and concentrated.

It is true that the bikers are also aware of the area outside the intensity, but with a clearly lower penetration which, however, is no disadvantage for the entertainment and for the concentration on the direct surroundings of the user.

The nightvisionscope can also be equipped with an integrated optical movement sensor which is directed towards the view outside the intensity area and which perceives and signalizes movements within the surroundings and the view area.

The movement sensor can be connected with an alarm system which indicates the user movements in the area outside the intensity sector over an optic display, for example with an indication signal or something similar, alternatively in another suitable way, for instance with an acoustic signal.

This is an advantage especially for mountain-biking if the biker (9) has to concentrate himself on the direct driving area in front of him, in particular the condition of the soil and possible obstacles.

Movements outside the concentration and view area are communicated to him with an movement sensor and an alarm system so that he can at least, if need be, concentrate himself and control the kind and the reason of the indicated movement.

When biking in open countries movements of animals or vehicles or similar events which often indicate obstacles or danger can be recognized in spite of high speed and darkness.

The biker (9) can react in a suitable way.

The movement sensor is preferably directed to the view in front of the user and the measure and view angle corresponds to the view the human eye has, respectively the view of a driver during the day.

Because of that only such movements are recognized which are inside the real driving area and within the area which is of interest for the biker. (8).

Moreover the direction and the view angle can be changed alternatively so that control in other areas especially all round control is possible.

In this case more than one movement sensor can be used.

The movement sensor is equipped as an optical construction part and constructed in a suitable way with an blow and push protection, especially with a soft rubber cover.

Additionally it can be constructed waterproof.

Therefore it can be used during climbing or during all kinds of water sport, like sailing, surfing or diving.

When diving the special advantage is that ho white light or light which is similar to the normal day light has to be used, which irritates the living creatures in the water and makes it difficult to observe them undisturbed.

With the nightvisionscope (2) the disturbing factor is not that high if not even not existing in many cases.

The entertainment gadget (1) can include beside the nightvisionscope (2) and the headgear (8) further accessories.

These are for example the above-mentioned pockets and bags for batteries or other accessories for the nightvisionscope (2).

Moreover there are special clothes which are suitable and adapted especially for this entertainment gadget (1).

These clothes are for example, at least partly fitted with reflexive materials which reflect or change infra-red-light or other suitable light, circumstances permitting in a special manner.

Infra-red-light appears in the nightvisionscope (2) mostly with a green tint. Trough suitable materials on the clothes or on the headgear (8) or on an other place of the entertainment gadget (1) a change in color can be effected.

Moreover it is possible to change the reflected light in another way through suitable accessories, for example to split the light in several single colors or to reach special light effects and the like through refraction.

Modifications of the indicated execution form are possible in several different ways.

In the indicated execution examples the nightvisionscope (2) is similar to normal glasses or field glasses with a view through both eyes.

Alternatively it is also possible to have the nightvisionscope constructed with just one objective (12) and one ocular (1).

The nightvisionscope (2) can also have another kind of fastening (3) and can also be fixed on other parts of the body.

It can also be fastened extern on the body depending on the use.

In further modifications of the suitable execution forms the nightvisionscope (2) can be equipped additionally with accessories for a normal view at day and rest light.

In particular the normal pictures transmitted by a suitable optic can be blot out or combined with the artificial pictures provided by the rest light amplifier and the picture transformer.

Explanation of the Numbers in the Following Pictures

1 entertainment gadget, sport gadget

2 nightvisionscope

3 fastening

4 mounting, flap device

5 hinge

6 head strap

7 head

8 headgear, helmet

9 biker

10 case

11 ocular

12 objective

13 arrangement of periscopes

14 infra-red-lights

1. Entertainment gadget, in particular sport gadget or gadget for children, characterized through the nightvisionscope included in the entertainment gadget.

2. Entertainment gadget, like 1) characterized through the fastening (3) on the nightvisionscope to fix it on the body or on the head of the user.

3. Entertainment gadget, like 1) or 2) characterized through having a mounting (4) on the fastening (3) to fix the nightvisionscope on the headgear, in particular on the helmet.

4. Entertainment gadget, like 1), 2) or 3) characterized through having a hinge on the mounting.

5. Entertainment gadget, like 1)-4) characterized through the head strip on the fastening.

6. Entertainment gadget, like 1)-5) characterized through having an arrangement of periscopes between ocular and objective on the nightvisionscope.

7. Entertainment gadget like 1)-6) characterized through having two oculars and two objectives for a view through both eyes.

8. Entertainment gadget like 1)-7) characterized through having integrated infra-red-lights.

9. Entertainment gadget like 1)-8) characterized through having an integrated supply of energy, particularly at least one battery.

10. Entertainment gadget like 1)-9) characterized through having a supply of energy fixed extern on the body.

11. Entertainment gadget like 1)-10) characterized through having a fix focus device on the nightvifionscope.

12. Entertainment gadget like 1)-11) characterized through having a fix focus device with intensity sector of up to about 25 meter.

13. Entertainment gadget like 1)-12) characterized through having an optic movement sensor with an alarm system on the nightvisionscope.

14. Entertainment gadget like 1)-13) characterized through having an optic movement sensor towards areas outside the intensity sector.

15. Entertainment gadget like 1)-14) characterized through having bags or similar facilities on the head protection (8) or on the clothes to carry the supply of energy, accessories for the nightvisionscope or especially batteries.

16. Entertainment gadget like 1)-15) characterized through having at least partly infra-red-reflective materials on the headgear (8) or the clothes of the user.
